(19) United States
(12) Patent Application Publication
(10) Pub. No.: US 2010/0071255 A1
(43) Pub. Date: Mar. 25, 2010

(54) Infestation tester for small insects

(76) Inventor: Shimon Zilbershlag, Baltimore, MD (US)

Correspondence Address: Dr. Shimon Zilbershlag, 3500 Olympia Avenue, Baltimore, MD, 21215, US

(21) Appl. No.: 12/284,784

(22) Filed: Sep. 25, 2008

(51) Int. Cl. A01M 3/00

(52) U.S. Cl. 43/107

(57) ABSTRACT

An insect infestation-blocking filter 300 is inserted into a main punctured container 400 with means to create gap thereunder. Filter 300 is placed on bottom 405 thereof to secure the main container's drain holes 406. An extra punctured container 200 with means to create gap thereunder is then stacked into the main container 400. Extra container's legs 204 stand on the filter 300 and press it down to main container's interior bottom 405. A sieve 100 is placed on top of the extra container 200. Sieve's handles 104 lean on extra container's rim 201. a fast-flow washable filter 300 may be used. Additional containers 200, filters 300 and sieves 100 can be added. Structure and materials allow fast drainage of fluids. All materials are washable, durable and reusable. All parts are removable and replaceable. A proper use yields within minutes easy to see evidence of infestation of small insects concentrated into about 7″ diameter.

### BACKGROUND OF THE INVENTION

1. Field of Invention

This invention generally relates to insect infestation testing specifically to insect infestation testing of small insects (such as but not limited to thrips and aphids) in crops, produce, plants, flowers, grains, seeds or foods. (Hence—“sampled item”)

2. Prior Art

Insect infestation causes big damages and costs to growers, to the food industries and to consumers. It hampers growth, appearance and marketability of crops, produce, plants, grains and flowers too. Also, insects might carry with it contaminants or viruses that are harmful to plant and human health. Another group that suffers is orthodox Jews who are allowed to consume only insect-free proofed food. Pesticides and other chemicals are helpful, but are also very expensive, harmful for humans and ecology and insects learn to resist them. Therefore it is essential to determine the level of insect infestation.

Testing for tiny insects (ranged about 0.3-3 mm) is extremely hard process and innovation in this area is needed. The smaller the insect, the harder is the detection, recognition and counting of it.

Previously, various methods have been used to evaluate the level of small-insect infestation. The simplest way is looking at the sampled item with bare eyes trying to find insects. However, some of the most harmful species are very small and their color is the same as the background. When insects don't move, they are hard to recognize and they seem meaningless. To help seeing these insects, some use a magnifying glass or place the sampled item on a light box. The problem is that looking at each sampled item individually is time consuming and tiring. Also, it is not cost effective for businesses. Another problem is that, it is extremely not efficient to use this method if the sampled item is cut, diced or shredded. It is also not efficient and very hard to use this method if the sampled item has curled of folded parts or leaves. Some use a microscope. Others take pictures of it with a digital camera and view it enlarged on a screen. Again, the problem is that looking for insects at each sampled item individually is time consuming and tiring. It also requires expensive equipment and professional help.

Therefore, there are methods to remove and collect the insects from the sampled item and then look at the collected objects. Two dry methods are brushing and vacuuming. There are brushing machines that brush insects off leaves. A 6″ round glass is placed at the bottom with some detergent smeared on it so brushed insects will stick to it. Then the round glass is placed under a microscope in a lab and the insects are counted and identified by a lab worker. The problems with this method are that the equipment and the lab services are expensive. This task is tiring and time consuming. It takes a while to send to the lab and get the results back. Also, the glass with the insects on it cannot be filed and stored because it is fragile, expensive. Vacuuming insects is still under research.

There are a few wet methods to remove and collect small insects from sampled items. One method is to soak sampled item in detergent, salt water, acids or other cleaning solutions. Some look at the fluids and try to spot insects floating on its surface or sunk at its bottom. This method is inaccurate because it is visually hard to see floating or sunk small insects in water. Others move their hands through the water trying to fish insects with a piece of filter. This method is also inaccurate because the user's hands create waves in the water. Those waves push insects away from the filter. So the problem is that this method cannot collect all the insects from the water, but only an unknown part of it.

Another way to treat the soaking fluids is by using a sieve. Then, the soaking fluids are poured on the sieve. The sieve is been flushed into vial. The vial will be poured on filter paper or petri dish and been observed by a microscope. It's a long process with many steps, expensive equipment and special skills are needed.

Another method is to soak sampled item in alcohol, remove the sampled item and pour the alcohol with the dead insects into a lab paper filter or a paper coffee filter. One problem is that it takes a long time for the liquids to pass through the paper filter. Another problem is that the wet paper filter gets torn easily and it takes a long time to dry. After all the liquids are filtered the filter is put under a microscope to count insects, identify and sort them. The problems with that are it is time consuming, causes fatigue, requires expensive professional help and equipment.

Insects' traps and flytraps may usually contain bait, screens, adhesive paper or poison. It usually provides a one-way entrance and then insects die inside it. Any of these traps do not remove insect infestation from sampled items. So, it cannot test insect infestation in any sampled item.

The prior art of washing machines for produce and others do not collect and separate very small insects from filtered dirt since they were not designed to test such an insect infestation.

The prior art of filters do not collect and separate insects from filtered dirt since they were not designed to test insect infestation.

The prior art of separating solids from liquids do not collect and separate insects from filtered dirt since they were not designed to test insect infestation.

The prior art of sampling takes only samples from fluids and does not test the entire fluid.

In the prior art testing infestation of small insects required a large working area, plural utensils, getting wet, wetting the working area, a lot of mess, extensive clean up after the process. It was time consuming, the evidence was hard to see and spread out on a large area or-in water on a large area. Producing more concentrated or accurate evidence took long-time, expensive equipment and labor and it took a long time to review and analyze the results.

### SUMMARY

In accordance with one embodiment a machine that tests infestation of small insects and produces concentrated evidence, comprising At least one punctured container with first means to create a gap there under for enabling fast drainage of fluids and At least one removable fast flow insect infestation blocking filter securing said container's exits for filtration of insect infestation from fluids, and Second means to attach said filter to bottom, walls and exits of said container and

Third means to modify flow of fluids and prevent flooding of said filter, and A sieve to separate the sample item from the fluids. Whereby within a few minutes said filter yields evidence that is concentrated within about 7″ diameter so evidence can be reviewed and analyzed fast, easy and economical.

### DRAWINGS—FIGURES

FIG. 1 is a view of a first embodiment of my invention

FIGS. 2 to 5 are perspective views from above of various parts of a first embodiment of my invention

FIG. 6 to 7 are is an inside view of various parts of a first embodiment of my invention

FIG. 8 is an inside view of a first embodiment of my invention assembled

FIG. 9 is a flowchart of one possible implementation of the method for infestation testing of small insects

### DRAWINGS—REFERENCE NUMERALS

| | | | |
|---|---|---|---|
| 100 | Sieve | 101 | Sieve's interior |
| 102 | Spaces in sieve's mesh | 103 | Sieve's rim |
| 104 | Sieve's handle | 105 | Sieve's mesh |
| 200 | Extra container | 201 | Extra container's rim |
| 202 | Extra container's | 203 | Extra container's walls |
| 204 | Means to create gap under | 205 | Extra container's |
| | extra container | | interior bottom |
| 206 | Extra container's | 207 | Extra container's gap under |
| | drain holes | | it |
| 300 | Filter | 301 | Filter's surface |
| 400 | Main container | 401 | Main container's rim |
| 402 | Main container's | 403 | Main container's walls |
| 404 | Means to create gap under | 405 | Main container's interior |
| | main container | | bottom |
| 406 | Main container's drain | 407 | Main container's gap under it |
| | holes | | |

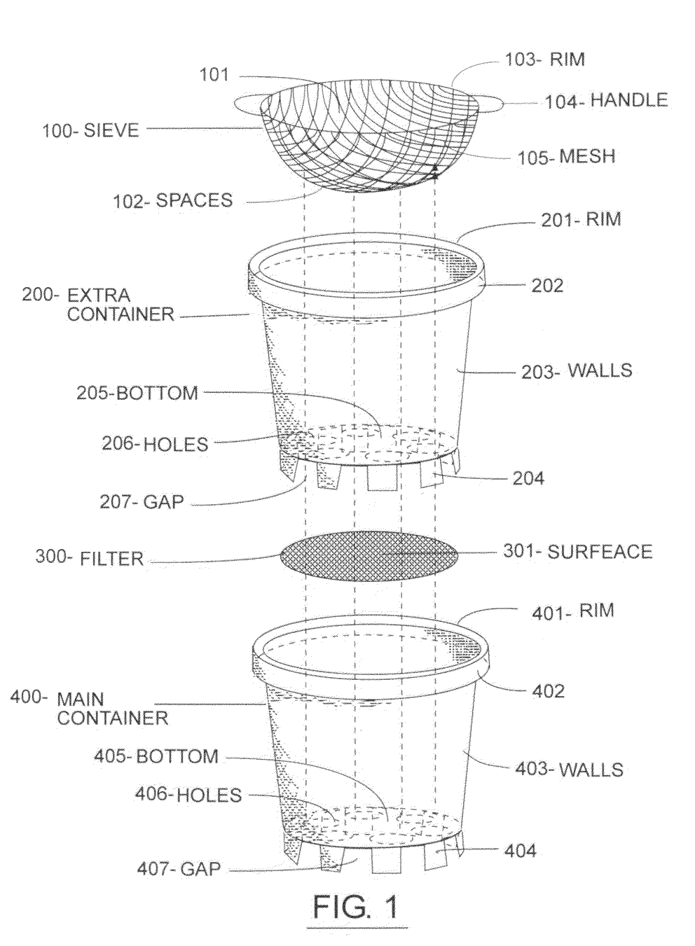

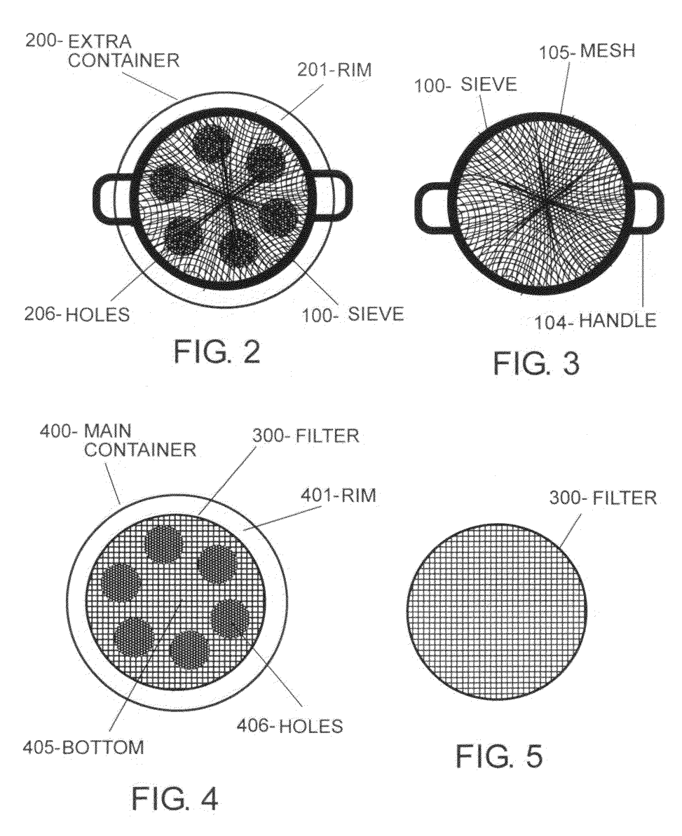

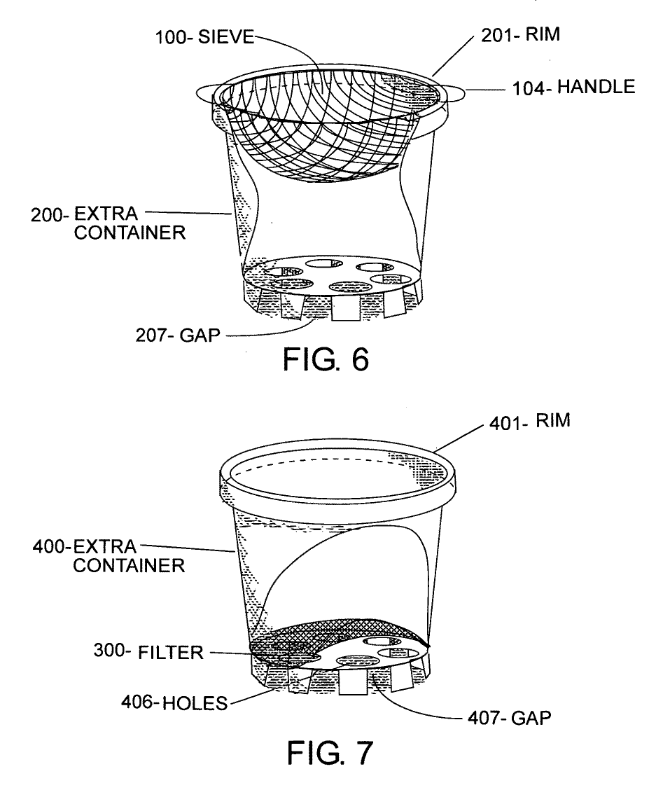

### DETAILED DESCRIPTION—FIRST EMBODIMENT—FIGS. 1 to 8

FIG. 1 shows a view of all parts of my invention and their right order of stacking for assembly. The parts are a main container 400 a filter 300 an extra container 200 a sieve 100.

FIG. 1, 4 and 7 show the main container 400. The main container 400 is punctured with plurality of holes 406 at its bottom 405. The holes 406 are big enough to allow fast drainage. Under the container there are means to create gap 404 which may be a plurality of legs under main container 400 from the surface it is standing on. The means to create gap 404 which may be a plurality of legs, create a gap 407 under the main container 400. The first embodiment is shaped like a cylinder but it can have other shapes too. Diameter of bottom 405 is about 6″ but it can have a different size. Walls 403 are 10″-15″ high.

At the top of the walls 403 there is a bump 402. The bump 402 allows stacking and separating easily the main container 400 from the extra container 200. The first embodiment is made of plastic, but any water resistant material can be used. For a prototype I used plastic planters for the containers.

FIG. 1, 4, 5 and 7 show the filter 300. The filter 300 is placed on the bottom of the main container 405. The filter 300 should secure all fluids exits. In the first embodiment the filter 300 is slightly bigger than the main container's bottom 405. It creates pressure and static between filter 300 edges and the main container's holes 406 and prevents shifting of the filter 300. The filter 300 is touching the main container's walls 403 all around. The filter 300 completely covers the entire holes 406 and touches the main container's bottom 405 allover. It causes tightness of the filter 330 against the main container walls 403 and holes 406. This tightness ensures the all the fluids coming through extra container's holes 206 will be enforced and directed to pass through the filter 300. The density of the filter 300 should be high enough to separate fluids from 0.3 mm long insects and up. It should also be fast draining and fast drying. In the first embodiment I used a greenhouse' screen; it prevents insects from entering greenhouses. The filter 300 is very dense, but fast draining, so it can be dried and reviewed. The filter 300 is made of strong plastic so it dries fast and also washable and reusable. The filter 300 is removable easily. For my prototype I used a white greenhouse screen and I cut it to a circle of about 7″ in diameter to match the size of the main container's bottom 405. However, filter can be made from any material and can have any shape, size or color desirable.

FIG. 1, 2 and 6 show the extra container 200. The extra container 200 is punctured with plurality of holes 206 at the bottom 205. The holes 206 are big enough to allow fast drainage. Under the container there are means to create gap 204 which may be a plurality of legs under the extra container 200. The means to create gap 204 which may be a plurality of legs, create a gap 207 under the extra container 200. The first embodiment is shaped like a cylinder but it can have other shapes too. Diameter of bottom 205 is about 6″ but it can have a different size. Walls 203 are 10″-15″ high. At the top of the walls 203 there is a bump 202. The bump 202 allows stacking and separating easily the extra container 200 from the extra container 200. The first embodiment is made of plastic, but any water resistant material can be used. The extra container 200 is stacked on the main container 400. The extra container's means to create gap 204 stands on the filter 300. The extra container's means to create gap 204 apply pressure to the filter 300 and attach it to the main container's bottom 405 to secure main container's drainage holes 406. The pressure and weight of he extra container 200 also prevents shifting of filter 300. In other words, filter 300 is sandwiched between extra container's means to create gap 204 to main container bottom 405. The extra container 200 can be substituted with a different method to attach the filter 300 to main container's drainage holes 406. The extra container 200 also balances and moderates the pace of fluid flow. It prevents flooding the filter and overflowing. Thus, no fluids escape filtration and no potential insects bypass the filter 300.

FIG. 1, 2, 3 and 6 show the sieve 100. The sieve 100 is placed on the extra container's rim 201. The sieve 100 has a plurality of handles 104 that lean on the extra container's rim 201. The inside of the sieve 101 is deep and wide enough to hold produce in it. The diameter of the sieve's rim 103 should be about the same like the extra container's rim 201. The density of the sieve's mesh 105 should allow the potential small insects to pass through the mesh' spaces 102, but also block particles of the sampled items.

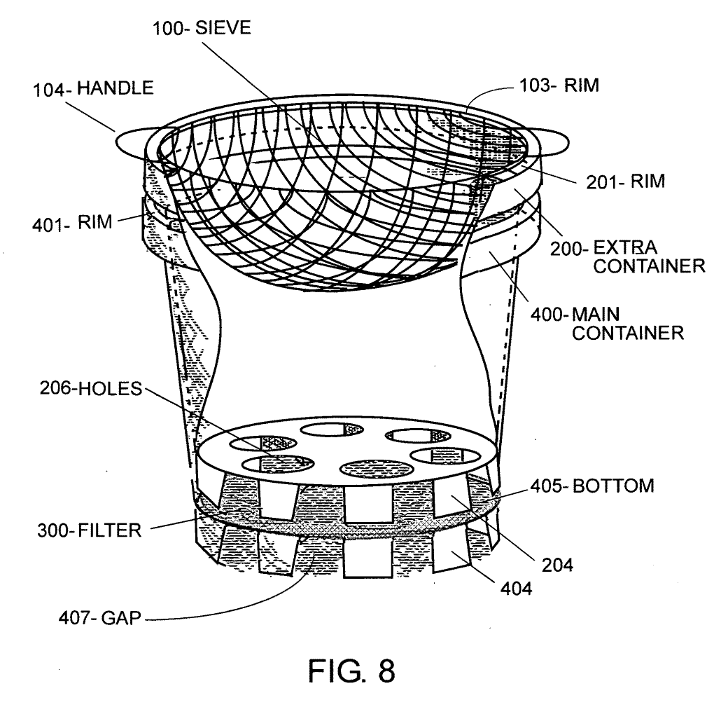

FIG. 8 shows an assembled first embodiment of my invention. To assemble the first embodiment, the main container 400 is placed in a sink. Then, the filter 300 is inserted into the main container 400 and placed on its bottom 405 so it secures the main container's drain holes 406. The extra container 200 is then stacked into the main container 400. Extra container's means to create gap 204 stand on the filter 300 and press it down to main container's interior bottom 405. In other words, filter 300 is sandwiched between extra container's means to create gap 204 to main container bottom 405. The sieve 100 is placed on top of the extra container 200. Sieve's handles 104 lean on extra container's rim 201.

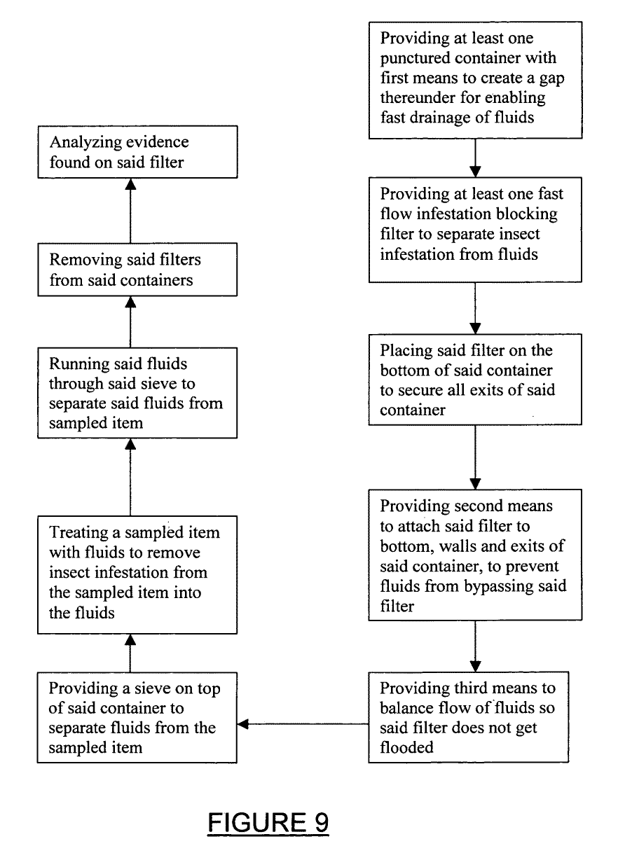

### Operation—First Embodiment—FIGS. 1 to 9

Invention is placed in a sink. A sampled item is placed in the sieve 100. The sampled item is washed for a few minutes with a jet stream of water coming from a faucet right above it. The water containing the small insects pass through the sieve's mesh 105 while the sampled item stays inside the sieve 100. The water and insect infestation flow into the extra container 200. They exit through holes 206. Then, the water with insect infestation is directed to the filter 300. The filter blocks the insect infestation and let the water to drain out. When all the water has drained through holes 406, the filter 300 is removed. The filter 300 contains all the small insects from the water, concentrated into a few inches. The filter can be scanned in a few minutes and conclusions can be made right away. The insect infestation can be easily noticed on the filter's surface 301.

The first embodiment of my invention, the infestation tester for small insects, should be assembled as explained above and may be placed in a sink. As mentioned above a sampled item can be produce, vegetables, fruits, crops, plants, leaves, grains, whole, cut or even shredded. The sampled item may be presoaked. The sampled item may be poured into the sieve 100 together with the soaking fluids. The sampled item may be sprayed while in the sieve 100. Additional fluids may be applied to the sampled item in the sieve 100. The user should follow his protocol for the amount and type of fluids. For example, the sampled item can be washed for a few minutes with a jet stream of water coming from a faucet right above it. This easy process can be repeated as many times as wanted. The filter 300 can be washed and reused immediately. Filter 300 may also be inserted into a sheet protector or just lay on paper towel for observation. It can be quickly checked with naked eyes or a magnifying glass. It can also be scanned into a computer, analyzed by computer software and saved to a database on the computer. Filter may also be filed in a sheet protector and retrieved later. Restaurants, food services and consumers can wash their vegetables and fruits in it and then check the filter 300. Also, as mentioned above, kosher food has to be proven as insects-free. Shredded or cut, too.

### Conclusion, Ramification, and Scope

Accordingly the reader will see that, according to one embodiment of the invention, I have provided a new combination, and a new use, that produces important results. It creates accurate evidence about infestation of small insects. Evidence that is produced reviewed and analyzed within minutes. Now, anyone can test infestation of small insects fast, easy and economical.

My invention turns insect infestation testing for the time into an easy, fast and economical procedure. It takes only a small working area. It may be done in a conventional sink using a regular faucet. On the other hand it can also be performed outdoors or in warehouses with quick on-the-spot results. No additional utensils are needed and the user doesn't get wet anymore. The surrounding area stays dry. No mess is created and no clean up is necessary. Washing, analyzing and concluding take a few minutes. The insect infestation comes out highly visible and concentrated into a small area. My invention saves users from fatigue. It also substantially lowers the costs, saves time and labor. Another unique feature is that even a very large amount of water can be tested accurately, by directing any amount of water into my invention. Also the process is short thanks to the fast flow filter 300 that my invention uses. This filter 300 is non-absorbent so it can be washed and reused immediately. The filter 300 is strong and durable. It dries fast so it can be scanned into a computer and be analyzed by computer software. Filter 300 may also be stored and filed. Or, it can be scanned and saved to a database. My invention uniquely separates the matters into three: the sampled item stays in sieve 100, and remains edible if proper fluids were used. It becomes cleaner and healthier; the insect infestation is collected on the filter 300; and all fluids drain out. Produce, vegetables, fruits, crops, plants, leaves, grains, whole, cut or even shredded. My invention can increase the profitability of agriculture because it makes it fast, easy and economical to test infestation of small insects even outdoors at any location, yielding accurate results that can be analyzed immediately, enabling a real-time response to an insect infestation problem.

My invention is useful for any entity interested in testing infestation of small insects, including: farmers, growers, pesticide companies, pesticides consultants, airport posts that check imported plants and produce, research teams in university or corporations, health departments, factories that produce canned fruits and vegetables, salad factories that wash and cut leafy vegetables and pack it in bags, foods warehouses, public kitchens, hospitals' kitchens, restaurants, food services and private consumers. Any kosher certified entities that process, use, pack, can, wash or cut leafy vegetables, fruits, vegetables or grains. For example: food factories, food services, restaurants, caterings, public kitchens, kosher certifying agencies and their supervisors. Kosher food consumers will be able to start buying the pre-washed and greens salads that are sold in grocery stores. Kosher consumers found it difficult to prove that certain produce is insects-free. My invention will enable them all for the first time to check greens cut into small pieces in few minutes.

While the above description contains many specifities, these should not be construed as limitations on the scope of any embodiment, but as exemplifications of the presently preferred embodiments thereof. Many other ramifications and variations are possible within the teachings of the various embodiments. For example, testing food safety. Also, improving the cleanliness and the healthiness of produce, leafy vegetables or grains. It's because my invention keeps the food in the sieve 100 and removes from it all the small particles of dirt and insects that are otherwise hard to notice. And then, the filter 300 can be reviewed for an assessment of food safety. Examples of such dirt are: hairs, insect infestation, sand, and others potentially hazardous contaminants or virus carriers.

Another ramification is to kosherize fresh or frozen vegetables or fruits that are sold precut or sealed in bags in grocery stores. Koshering such products mean that they have to be proven as visibly insect free. There are many brands that make such products. However, insect-proofing an entire production line might be too expensive and burdensome. The pace of production is fast and cannot be slowed down. My invention solves this problem, too. Kosher factories, kosher food services and kosher agencies can use my invention to perform numerous tests everyday on any quantity of produce and water. My invention promotes a healthier nutrition for kosher consumers.

While the above description contains many specifities, these should not be construed as limitations on the scope of any embodiment, but as exemplifications of the presently preferred embodiments thereof. Many other. ramifications and variations are possible within the teachings of the various embodiments, for example, health cleanliness and food safety promotion.

Thus, the scope of the invention should be determined by the appended claims and their legal equivalents, and not by the examples given.

I claim:

1. A machine that tests infestation of small insects and produces concentrated evidence, comprising:
(a) At least one punctured container with first means to create a gap there under for enabling fast drainage of fluids, and
(b) At least one removable fast flow insect infestation blocking filter laid on bottom of said container and securing said container's exits for filtration of insect infestation from fluids, and
(c) Second means to attach said filter to bottom, walls and exits of said container, and
(d) Third means to modify flow of fluids and prevent flooding of said filter, and
(e) A sieve on top of said container to separate the sample item from the fluids.
Whereby within a few minutes said machine yields accurate evidence of insect infestation, which is concentrated within about, 7″ diameter so evidence can be reviewed and analyzed fast, easy and economical.

2. The machine of claim 1 wherein said first means is a plurality of legs

3. The machine of claim 1 wherein said first means are a stand

4. The machine of claim 1 wherein said containers are made of planters with holes at their bottom.

5. The machine of claim 1 wherein said filter is made of a type of material that is used in greenhouses as a screen that blocks out insects about 0.3 mm in size and up

6. The machine of claim 1 wherein said filter is made of paper

7. The machine of claim 1 wherein said filter is sandwiched between the bottom of two said containers stacked into each other and a sieve is put on top of said upper container.

8. The machine of claim 1 wherein said second and third means are additional said container stacked on said container so that the legs of the upper said container stand on said filter pressing it down and forcing said filter to stay in place at the bottom of the lower said container and the holes at the bottom of upper said container balance flow of fluids to said filter

9. The machine of claim 1 wherein said sieve is a strainer with handles and without legs thereunder.

10. A method of testing infestation of small insects and producing concentrated evidence, comprising the steps of:
(a) Providing at least one punctured container with first means to create a gap thereunder for enabling fast drainage of fluids, and
(b) Providing at least one fast flow insect infestation-blocking-filter to separate insect infestation from fluids, and
(c) Placing said filter on the bottom of said container to secure all exits of said container, and
(d) Providing second means to attach said filter to bottom, walls and exits of said container, to prevent fluids from bypassing said filter, and
(e) Providing third means to balance flow of fluids so said filter does not get flooded, and
(f) Providing a sieve on top of said containers to separate fluids from the sampled item, and
(g) Treating a sampled item with fluids to remove insect infestation from the sampled item into the fluids, and
(h) Running said fluids
(I) Through said sieve to separate said fluids from sampled item, then
(II) Into said containers to balance and direct stream of said fluids, then
(III) Through said filter to separate insect infestation from said fluids, and
(i) Removing said filters from said containers, and
(j) Analyzing evidence found on said filter.
Whereby method is fast, easy, economical, way to test infestation of small insects, allows immediate analysis and response since method quickly yields on said filter evidence concentrated within about 7″ diameter.

11. The method of claim 10 wherein said containers are placed in a sink.

12. The method of claim 10 wherein said fluids are edible

13. The method of claim 10 wherein said fluids are non edible

14. The method of claim 10 wherein sampled item is presoaked in fluids, which are then poured into said sieve.

15. The method of claim 10 wherein sampled item is sprayed with fluids.

16. The method of claim 10 wherein sampled item is placed in said sieve and washed under a stream of water.

17. The method of claim 12 wherein only the soaking fluids are poured into said sieve.

18. The method of claim 12 wherein said filter is reviewed with magnifying means.

19. The method of claim 10 wherein said magnifying means are scanning said filter into a computer and watching an enlarged image of said filter on a computer screen.

20. The method of claim 10 wherein said filter is scanned into a computer.

21. A new use that produces concentrated evidence of insect infestation within a diameter of about 7″ comprising:
(a) Treating a sampled item with fluids, and then
(b) Running at least said fluids through a sieve into a punctured container which is lined with a greenhouse screening material securing all exits thereof, and
(c) Filtering said fluids through said greenhouse screening material.
Whereby new use creates a fast, easy and economical way to test infestation of small insects, yields a clear evidence which allows immediate analysis and response to insect infestation condition.

22. The new use of claim 19 wherein said filter is magnified by scanning said filter into a computer and watching an enlarged image of said filter on a computer screen.
